(19) United States
(12) Patent Application Publication
(10) Pub. No.: US 2020/0023800 A1
(43) Pub. Date: Jan. 23, 2020

(54) VEHICULAR SEAT DEVICE AND AIR PRESSURE CONTROL METHOD FOR VEHICULAR SEAT

(71) Applicants: AISIN SEIKI KABUSHIKI KAISHA, Kariya-shi (JP); TOYOTA JIDOSHA KABUSHIKI KAISHA, Toyota-shi (JP)

(72) Inventors: Yuki FUJII, Obu-shi (JP); Akiyoshi SHIBATA, Nagoya-shi (JP); Hiroyuki ODA, Hamamatsu-shi (JP); Shunsuke HAYAKAWA, Obu-shi (JP); Shunsuke TANAKA, Nisshin-shi (JP); Shinichiro KOMAKI, Toyota-shi (JP); Kenji HASHIMOTO, Nisshin-shi (JP)

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 16/338,028

(22) PCT Filed: Oct. 5, 2017
(86) PCT No.: PCT/JP2017/036292

§ 371 Date: Mar. 29, 2019

(30) Foreign Application Priority Data
Oct. 6, 2016 (JP) 2016-198143

(51) Int. Cl. B60R 21/015; B60N 2/00; B60R 21/207

(52) U.S. Cl. CPC B60R 21/01552; B60R 21/207; B60N 2/002

(57) ABSTRACT

A vehicle seat device includes a reproduction control portion configured to inflate an airbag provided in a seat based on an internal pressure target value, an occupant detection portion configured to detect a seated state in which an occupant is seated on the seat, a body size detection portion configured to detect a size of the occupant, and a correction amount calculation portion configured to calculate, based on the size of the occupant, a correction amount to be used to correct the internal pressure target value in a non-seated state in which the occupant is not seated on the seat.

### TECHNICAL FIELD

The present invention relates to a vehicle seat device and a method for controlling air pressure of a vehicle seat.

### BACKGROUND ART

Some vehicle seat devices can change the seat support shape by inflating and deflating airbags (bladders) provided inside a seat. Typically, in such a seat device, an internal pressure target value is set for each of the airbags. The seat device is configured to perform reproduction control that reproduces the seat support shape by inflating the airbags based on the internal pressure target values, when starting up a vehicle.

The internal pressures of the airbags are significantly changed depending on whether an occupant is seated on a seat. That is, when the above-described reproduction control of the seat support shape is performed in a non-seated state, in which the occupant's seating load is not applied, the airbags will be greatly inflated. When the occupant is seated on the seat in this state, the occupant may feel uncomfortable. Therefore, as can be seen in, for example, Patent Document 1 and Patent Document 2, and the like, in conventional technologies, it is common to start the reproduction control after the occupant is seated.

### PRIOR ART DOCUMENTS

### Patent Documents

Patent Document 1: Japanese Examined Patent Publication No. 6-95969

Patent Document 2: Japanese Laid-Open Patent Publication No. 2002-315657

### SUMMARY OF THE INVENTION

### Problems that the Invention is to Solve

However, in the configuration that starts the reproduction control upon the seating of the occupant as in the conventional technologies, it takes time before reproducing an optimum seat support shape. Additionally, since this has been preventing further improvement of the convenience, there has still been a room for improvement in this point.

An objective of the present invention is to provide a vehicle seat device and an air pressure control method for a vehicle seat that can properly inflate an airbag even in a non-seated state.

### Means for Solving the Problems

To achieve the foregoing objective, a vehicle seat device preferably includes a reproduction control portion configured to inflate an airbag provided in a seat based on an internal pressure target value, an occupant detection portion configured to detect a seated state in which an occupant is seated on the seat, a body size detection portion configured to detect a size of the occupant, and a correction amount calculation portion configured to calculate, based on the size of the occupant, a correction amount to be used to correct the internal pressure target value in a non-seated state in which the occupant is not seated on the seat.

To achieve the foregoing objective, a method for controlling air pressure of a vehicle seat preferably includes inflating an airbag provided in a seat based on an internal pressure target value, detecting a seated state in which an occupant is seated on the seat, detecting a size of the occupant, and calculating, based on the size of the occupant, a correction amount to be used to correct the internal pressure target value in a non-seated state in which the occupant is not seated on the seat.

### BRIEF DESCRIPTION OF THE DRAWINGS

FIG. 1 is a perspective view of a vehicle seat inside which airbags are provided.

FIG. 2 is a block diagram illustrating a schematic configuration of a seat device.

FIG. 3 is a schematic configuration diagram of a memory operation portion.

FIG. 4 is an explanatory diagram of seat support data.

FIG. 5 is a flowchart illustrating a processing procedure of reproduction control.

FIG. 6 is a flowchart illustrating a processing procedure of registration control.

FIG. 7 is a schematic configuration diagram of a power seat.

FIG. 8 is an explanatory diagram of seat position data.

FIG. 9 is a graph illustrating the relationship between a correction amount of an internal pressure target value and a slide position of a seat.

FIG. 10 is a flowchart illustrating a processing procedure of provisional correction reproduction control.

### MODES FOR CARRYING OUT THE INVENTION

Referring to the drawings, a pneumatic seat device having a seat support function according to an embodiment will now be described.

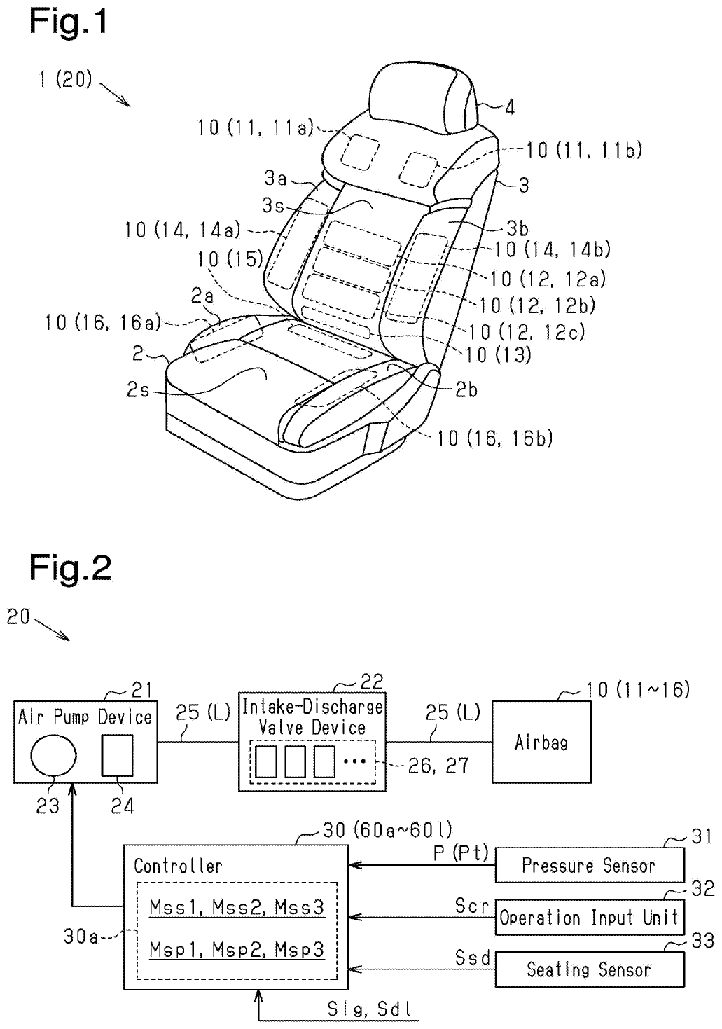

As shown in FIG. 1, a vehicle seat 1 includes a seat cushion 2 and a seat back 3, which is at the rear end of the seat cushion 2. A headrest 4 is arranged on the upper end of the seat back 3.

The seat back 3 has the shape in which each of opposite side sections 3a and 3b bulges toward the front. Further, the seat cushion 2 also has the shape in which each of opposite side sections 2a and 2b bulges upward. The seat 1 thus allows an occupant to be seated with a good posture, and also maintains the posture of the occupant.

The the seat cushion 2 and the seat back 3 incorporate airbags 10 (11 to 16). Specifically, independent airbags 11 (11a, 11b), 12 (12a to 12c), and 13 are provided inside the seat back 3 at the positions corresponding to a shoulder supporting portion, a waist supporting portion and a bottom end portion (pelvis supporting portion) of a backrest surface 3s, respectively. Additionally, independent airbags 14 (14a, 14b) are provided inside the seat back 3 at the positions corresponding to its side sections 3a and 3b, respectively. Further, as for the seat cushion 2, independent airbags 15 and 16 (16a, 16b) are also provided inside a rear end portion (pelvis supporting portion) and inside the side sections 2a and 2b of a seat surface 2s, respectively. Accordingly, a seat device 20 is formed that can change the seat support shape based on inflating and deflating of each of the airbags 10.

As illustrated in FIG. 2, the seat device 20 includes an air pump device 21 that pumps air to each of the above-described airbags 10, and an intake-discharge valve device 22 that is interposed between these airbags 10 and the air pump device 21. The air pump device 21 is, for example, an electric pump that drives a pump mechanism 24 by using a motor 23 as the driving source. The intake-discharge valve device 22 is connected to each of the airbags 10 and the air pump device 21 via air tubes 25 made of a plastic and having flexibility. These air tubes 25 and the internal passage of the intake-discharge valve device 22 form an air flow passage L that communicates with each of the airbags 10 and the air pump device 21. The intake-discharge valve device 22 includes intake valves 26 and discharge valves 27, and the intake valves 26 and the discharge valves 27 are arranged in the middle of the flow passage L extending from the air pump device 21 to the airbags 10.

The intake valves 26 and the discharge valves 27, as well as the air pump device 21 are controlled by a controller 30. Specifically, an internal pressure P of each of the airbags 10 detected by a pressure sensor 31 is input to the controller 30. Additionally, an operation input signal Scr is input to the controller 30 from an operation input portion 32. In addition, an output signal Ssd of a seating sensor 33 provided in the seat 1, and an ignition signal Sig and a door lock signal Sdl, are further input to the controller 30. The controller 30 controls the operation of the corresponding intake valves 26 and discharge valves 27 as well as the air pump device 21, so as to make each of the airbags 10 inflate and deflate based on these input signals. Additionally, the controller 30 detects a seated state in which the occupant is seated on the seat 1, and the non-seated state in which no occupant is seated on the seat 1, based on the output signal Ssd of the seating sensor 33.

To be more specific, the controller 30 sets the target value (internal pressure target value Pt) for the internal pressure P of each of the airbags 10. The internal pressure target value Pt of each of the airbags 10 is updated as needed when the occupant seated on the seat 1 sets the optimum seat support shape by using an operation switch (not shown) that forms the above-described operation input portion 32 provided in a side surface of the seat 1. The operation on the operation input portion 32 for setting the seat support shape is referred to as “the support shape adjustment operation.” The controller 30 controls the operation of the above-described air pump device 21 and intake-discharge valve device 22, so that the detected internal pressure P of each of the airbags 10 matches the internal pressure target value Pt.

The controller 30 deflates each of the airbags 10 by releasing the air in each of the airbags 10 provided in the seat 1 at the end of traveling of the vehicle (at the time of IG OFF). The controller 30 reproduces the seat support shape by inflating each of the airbags 10 again after starting the vehicle (after IG ON).

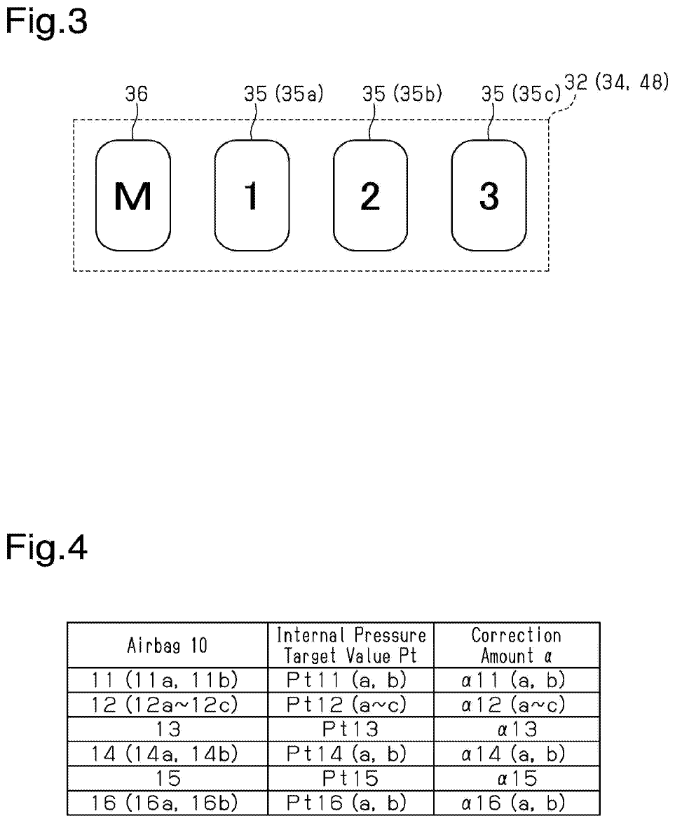

As illustrated in FIG. 3, the operation input portion 32 includes a memory operation portion 34 provided in the inner panel of a vehicle door, which is not shown. The memory operation portion 34 includes multiple (in this embodiment, three) selection switches 35 (35a to 35c), and a memory switch 36. The seat device 20 can store and reproduce the seat support shape through operating the memory operation portion 34.

Specifically, as illustrated in FIGS. 2 and 4, multiple (three) sets of seat support data Mss (Mss1 to Mss3) associated with the above-described selection switches 35 (35a to 35c), respectively, are stored in a storage region 30a of the controller 30. Each set of the seat support data Mss includes the internal pressure target value Pt (Pt11 to Pt16) of each of the airbags 10 (11 to 16) provided in the seat 1.

When any of the selection switches 35 (35a to 35c) is operated, the controller 30 reads the seat support data Mss corresponding to the operated selection switch 35 from the storage region 30a. For example, when a first operation switch 35a is operated, the controller 30 reads first seat support data Mss1, and when a second operation switch 35b is operated, the controller 30 reads second seat support data Mss2. The controller 30 inflates each of the airbags 10 (11 to 16) based on the internal pressure target value Pt (Pt11 to Pt16) included in the read seat support data Mss. Accordingly, it is possible to reproduce the seat support shape associated with each of the selection switches 35. The control for reproducing the seat support shape as described above is referred to as “the reproduction control.”

Additionally, when any of the selection switches 35 (35a to 35c) is operated after the memory switch 36 is operated, the controller 30 updates the internal pressure target value Pt of each of the airbags 10 included in the seat support data Mss corresponding to the operated selection switch 35 with the current value of the internal pressure P of the airbag 10. That is, the pressure sensor 31 detects the internal pressure P of each of the airbags 10 (11 to 16), and registers the detected value in the storage region 30a as a new internal pressure target value Pt (Pt11 to Pt16). Accordingly, it is possible to store the optimum seat support shape that is set by the above-described support shape adjustment operation by associating the optimum seat support shape with each of the selection switches 35 (35a to 35c). The control for registering the seat support shape as described above is referred to as “the registration control.”

Further, the controller 30 stores, as the seat support data Mss (Mss1 to Mss3), a correction amount α (α11 to α16) to be used to correct each of the internal pressure target values Pt (Pt11 to Pt16) in a case where each of the airbags 10 (11 to 16) is inflated in the non-seated state, in which no occupant is seated on the seat 1. That is, when the selection switch 35 of the memory operation portion 34 is operated in a state in which the non-seated state of the occupant is detected based on the output signal Ssd of the seating sensor 33, the controller 30 inflates each of the airbags 10 based on each internal pressure target value Pt and each correction amount α that are stored in the storage region 30a as the seat support data Mss corresponding to the operated selection switch 35. Each of the airbags 10 is inflated based on a corrected internal pressure target value obtained by correcting the corresponding internal pressure target value Pt by using the corresponding correction amount α. Accordingly, it is possible to properly inflate each of the airbags 10 even in the non-seated state of the occupant.

The controller 30 may include a microcomputer and/or dedicated hardware (an application-specific integrated circuit (ASIC)) that performs at least part of various processes. That is, the controller 30 may be configured as circuitry that includes: 1) at least one processor (microcomputer) that operates according to a computer program (software); 2) at least one dedicated hardware circuit, such as an ASIC; or 3) a combination of 1) and 2).

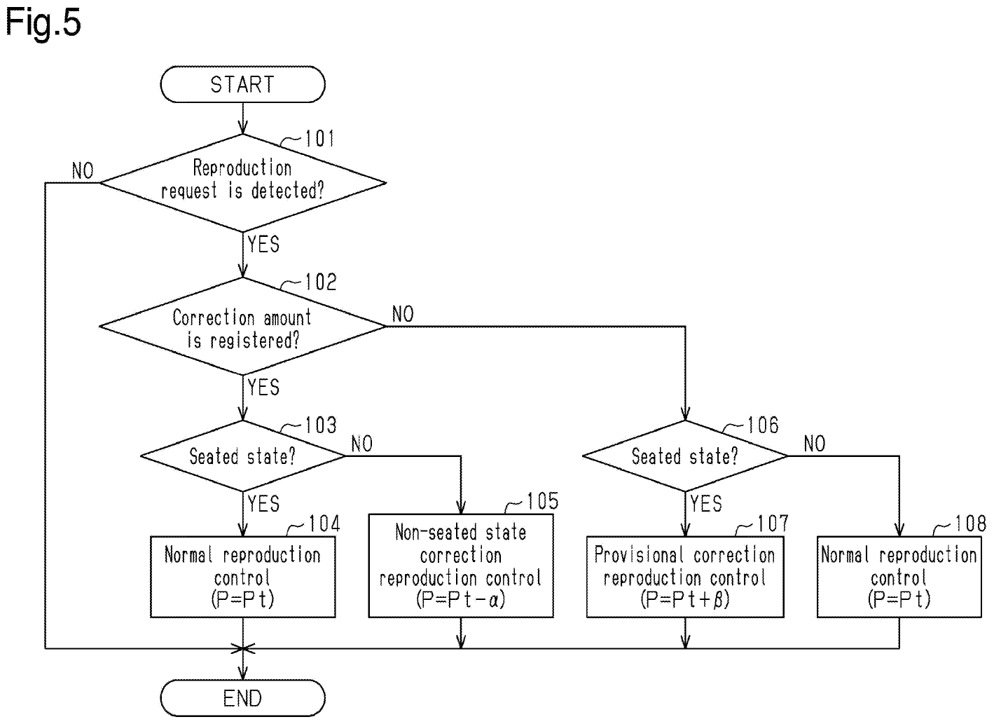

As illustrated in the flowchart of FIG. 5, when the controller 30 detects a reproduction request based on the operation on the selection switch 35 of the memory operation portion 34 (step 101: YES), the controller 30 determines whether the correction amount α of the internal pressure target value Pt is registered as the seat support data Mss corresponding to the operated selection switch 35 (step 102). When the controller 30 determines in this step 102 that the correction amount α of the internal pressure target value Pt is registered (step 102: YES), subsequently, the controller 30 determines whether the occupant is in the seated state, in which the occupant is seated on the seat 1, based on the output signal Ssd of the seating sensor 33 (step 103). When the occupant is in the seated state (step 103: YES), the controller 30 performs ordinary reproduction control that inflates each of the airbags 10 based on the internal pressure target value Pt registered in the storage region 30a. (Step 104). When the occupant in not in the seated state, i.e., when the occupant is in the non-seated state (step 103: NO), the controller 30 performs non-seated state reproduction control that inflates each of the airbags 10 based on the internal pressure target value Pt and the correction amount α (step 105).

In the above-described step 102, when the controller 30 determines that the correction amount α of each internal pressure target value Pt is not registered (step 102: NO), subsequently, the controller 30 determines whether the occupant is in the seated state (step 106). When the occupant is in the seated state (step 106: YES), the controller 30 performs provisional correction reproduction control described below (step 107), and when the occupant is not in the seated state, i.e., when the occupant is in the non-seated state (step 106: NO), the controller 30 performs the ordinary reproduction control that inflates each of the airbags 10 based on each internal pressure target value Pt stored in the storage region 30a (step 108).

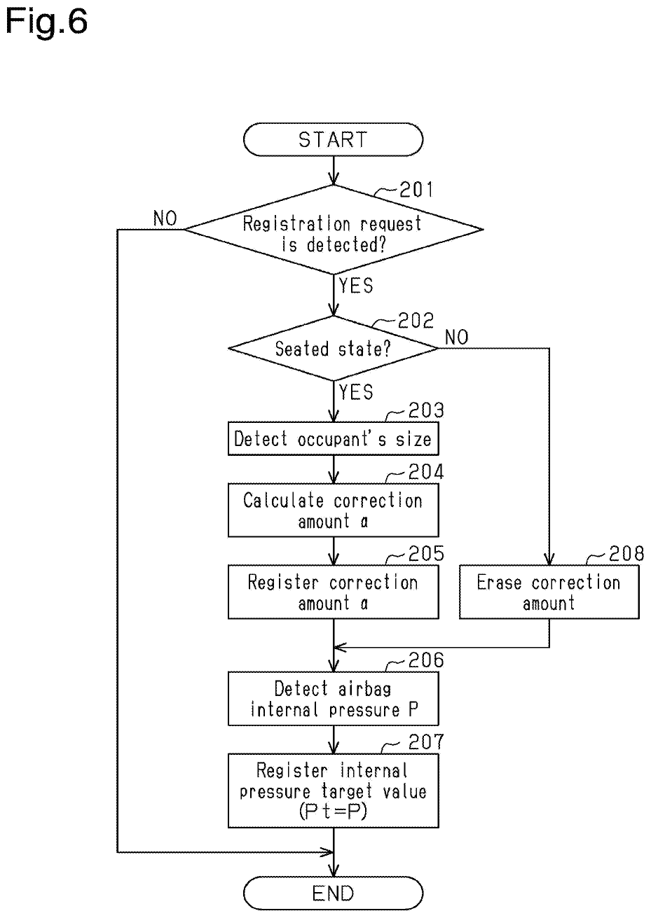

Additionally, as illustrated in the flowchart of FIG. 6, when the controller 30 detects a registration request based on the operation on the memory switch 36 (and the selection switch 35) of the memory operation portion 34 (step 201: YES), the controller 30 determines whether the occupant is in the seated state based on the output signal Ssd of the seating sensor 33 (step 202). In this step 202, when the controller 30 determines that the occupant is in the seated state (step 202: YES), the controller 30 performs detection determination for the size of the occupant seated on the seat 1 (step 203). The controller 30 calculates the correction amount α of the internal pressure target value Pt corresponding to each of the airbags 10 based on the detected occupant's size (step 204).

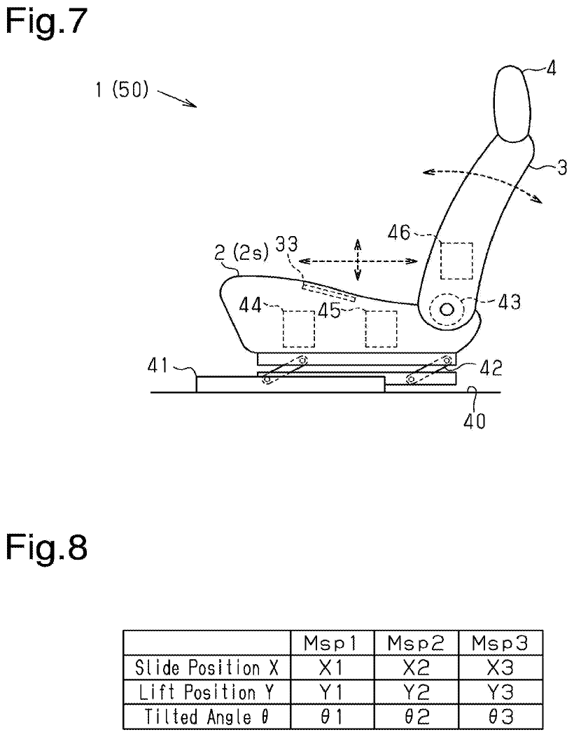

Specifically, as illustrated in FIG. 7, the seat 1 is supported on a seat slide device 41 that is installed on a floor 40 of the vehicle and changes the slide position of the seat 1 in the front and back direction. A seat lifter device 42 for changing the lift position of the seat 1 (seat cushion 2) is provided between the seat slide device 41 and the seat 1. A pressure-sensitive switch (membrane switch), which is switched into a turned-on state when the occupant who is seated on the seat 1 presses down the seat surface 2s of the seat cushion 2, is used as the seating sensor 33 of the present embodiment. Further, a seat reclining device 43 for changing the tilted angle of the seat back 3 is provided in the seat 1. The seat 1 has a configuration as a so-called power seat (50) that drives these seat slide device 41, seat lifter device 42, and seat reclining device 43 by actuators 44 to 46 using motors that are not shown as the driving sources, respectively.

As illustrated in FIG. 3, the above-described memory operation portion 34 also serves as the memory operation portion 48 for performing the registration operation that stores the seat position adjusted by using a function as this power seat 50, and performs the reproduction operation that reproduces the registered seat position. Additionally, as illustrated in FIG. 2, the controller 30 stores, in its storage region 30a, multiple (three) sets of seat position data Msp (Msp1 to Msp3) associated with the selection switches 35 (35a to 35c) of the memory operation portion 34, respectively. In the occupant's size detection determination in step 203 in FIG. 6, the controller 30 reads the seat position data Msp corresponding to the operated selection switch 35 among the seat position data Msp stored in this storage region 30a.

As illustrated in FIG. 8, each seat position data Msp (Msp1 to Msp3) includes a slide position X (X1 to X3) of the seat 1, a lift position Y of the seat 1 (Y1 to Y3), and a tilted angle θ of the seat back 3 (θ1 to θ3). The more backward the seat 1 is slid, the greater the value of the slide position X becomes. The higher the seat cushion 2 is placed, the greater the value of the lift position Y becomes, and the more backward the seat back 3 is tilted from a predetermined neutral position, the greater the value of the tilted angle θ becomes. The controller 30 performs the occupant's size detection determination by reading the slide position X registered in the storage region 30a as the seat position data Msp.

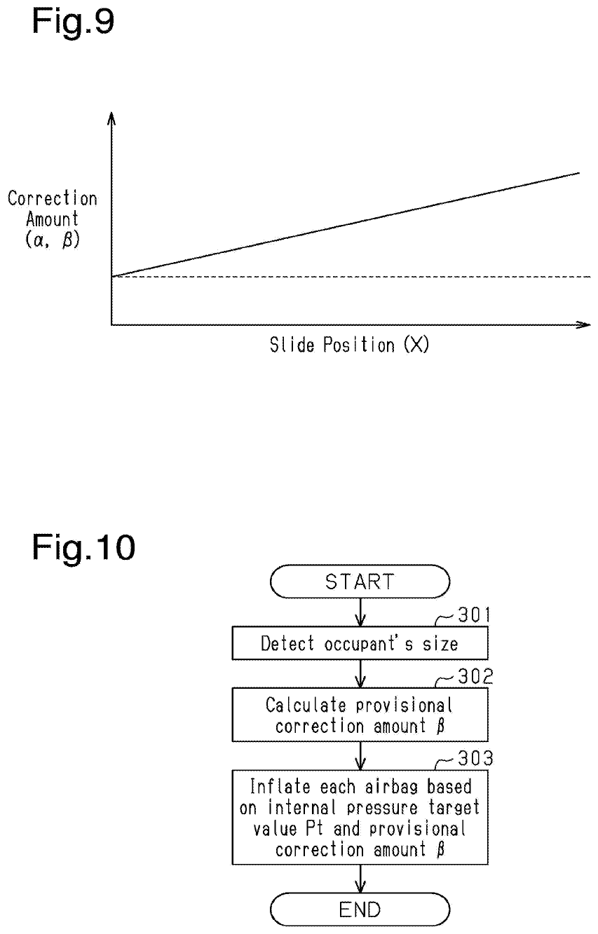

As illustrated in FIG. 9, in the calculation process of the correction amount α regarding the internal pressure target value Pt in step 204 in FIG. 6, the larger the value of the slide position X that is read from the storage region 30a, the greater the correction amount α that is calculated by the controller 30 becomes. That is, the estimation is performed such that the more backward the seat 1 is slid, the larger the size of the occupant is. When the occupant is seated on the seat 1 in which each of the airbags 10 has already been inflated in the non-seated state, the larger the size of the occupant is, the higher the internal pressure P of each of the airbags 10 rises.

In light of this, in the non-seated state correction reproduction control in step 105 in FIG. 5, the controller 30 inflates each of the airbags 10 so that the internal pressure P of each of the airbags 10 becomes the value obtained by subtracting the above-described correction amount α from the corresponding internal pressure target value Pt (P=Pt−α). Accordingly, even when each of the airbags 10 is started to be inflated before the occupant is seated on the seat 1, it is possible to realize the optimum seat support shape after the seating by the occupant.

As illustrated in FIG. 6, when the controller 30 calculates the correction amount α of each internal pressure target value Pt as described above, the controller 30 registers the value in the storage region 30a (step 205). Further, the controller 30 detects the internal pressure P of each of the airbags 10 in the stage where the registration request was detected in the above-described step 201, i.e., the current value of the internal pressure P (step 206). The controller 30 registers the current value of the internal pressure P in the storage region 30a as the internal pressure target value Pt (step 207).

Additionally, in the above-described step 202, when the controller 30 determines that the occupant is not in the seated state, i.e., when the controller 30 determines that the occupant is in the non-seated state (step 202: NO), the controller 30 erases each correction amount α registered in the storage region 30a as the seat support data Mss (step 208). Thereafter, the controller 30 performs the internal pressure detection process of each of the airbags 10 in step 206, and the registration process of the internal pressure target value Pt in step 207.

The flowchart in FIG. 10 illustrates a processing procedure of the provisional correction reproduction control illustrated in step 107 in FIG. 5. As illustrated in FIG. 10, the controller 30 performs the occupant's size detection determination (step 301) in the same manner as in step 203 in FIG. 6, and calculates a provisional correction amount β in the same manner as in step 204 in FIG. 6 (see step 302 and FIG. 9). The controller 30 inflates each of the airbags 10 based on this provisional correction amount β and the internal pressure target value Pt registered in the storage region 30a (step 303).

It is assumed that a request for performing such provisional correction reproduction control is generated before inflating each of the airbags 10. The controller 30 performs the provisional correction reproduction control by inflating each of the airbags 10 so that the internal pressure P of each of the airbags 10 becomes the value obtained by adding the above-described provisional correction amount β to the corresponding internal pressure target value Pt (step 107 of FIG. 5).

That is, the larger the size of the occupant is, the greater the internal pressure P of each of the airbags 10 required to realize the optimum seat support shape becomes. In light of this, the larger the size of the occupant seated on the seat 1, the greater the provisional correction amount β calculated by the controller 30 becomes. By performing the provisional correction reproduction control based on this provisional correction amount β and the internal pressure target value Pt, it is possible to realize the optimum seat support shape even for the occupant for whom the internal pressure target value Pt of each of the airbags 10 is not registered.

The present embodiment has the following advantages.

(1) The controller 30, which functions as a reproduction control portion 60a, inflates the airbags 10 provided inside the seat 1 based on the respective corresponding internal pressure target values Pt. Additionally, the controller 30, which functions as an occupant detection portion 60b, detects the seated state, in which the occupant is seated on the seat 1. When the controller 30 detects the seated state, the controller 30 inflates the airbags 10 based on the internal pressure target values Pt. When the controller 30 does not detect the seated state, i.e., when the controller 30 detects the non-seated state, in which no occupant is seated on the seat 1, the controller 30 corrects the internal pressure target values Pt by using the correction amount α, and inflates the airbags 10 based on the corrected internal pressure target values. Additionally, when the controller 30, which functions as an occupant detection portion 60b and a body size detection portion 60c, detects the seated state, the controller 30 detects the size of the occupant. The controller 30, which functions as a correction amount calculation portion 60d, calculates the correction amount α based on the detected size of the occupant.

That is, when the occupant is seated on the seat 1 in the state in which the airbag 10 are already inflated, the larger the size of the occupant, the higher the internal pressures P of the airbags 10 rise. In this regard, according to this configuration, it is possible to properly inflate the airbags 10 so that the internal pressures P of the airbags 10 become optimum values according to the size of the occupant, by using the correction amount α in the non-seated state, in light of the fact that the occupant is seated on the seat 1 after the airbags 10 are inflated. As a result, it is possible to realize the optimum seat support shape after the seating by the occupant, even when the airbags 10 are started to be inflated before the occupant is seated on the seat 1. Accordingly, since it is possible to reproduce the seat support shape more quickly, the user's convenience is improved.

(2) The controller 30, which functions as a registration request detection portion 60e, detects the registration request based on the operation on the memory switch 36 of the memory operation portion 34. Additionally, when the controller 30, which functions as an internal pressure target value registration portion 60f, detects the registration request, the controller 30 registers the current values of the internal pressures P of the airbags 10 in the storage region 30a as the internal pressure target values Pt. When the controller 30, which functions as a correction amount registration portion 60g, detects the registration request in the occupant's seated state, the controller 30 registers the correction amount α calculated in the seated state in the storage region 30a.

That is, the calculation of the correction amount α with a higher precision is enabled by adopting the configuration that uses the correction amount α calculated in the seated state. Additionally, the options for methods of calculating the correction amount α are extended. Accordingly, the airbags are properly inflated even in the occupant's non-seated state.

(3) When the controller 30, which functions as a registered correction amount erasing portion 60h, detects the registration request in the occupant's non-seated state, the controller 30 erases the correction amount α registered in the storage region 30a.

According to the above-described configuration, the registered correction amount α can be easily erased. Accordingly, the user's convenience is improved for, for example, preparing for the cases of usage by other occupants in the next and following times.

(4) The controller 30, which functions as a reproduction request detection portion 60i, detects the reproduction request based on the operation on the selection switch 35 of the memory operation portion 34. Additionally, when the controller 30, which functions as a seated state reproduction control portion 60j, detects the reproduction request in the occupant's seated state, the controller 30 inflates the airbags 10 based on the internal pressure target values Pt registered in the storage region 30a. When the controller 30, which functions as a non-seated state reproduction control portion state 60k, detects the reproduction request in the occupant's non-seated state, the controller 30 inflates the airbags 10 based on the internal pressure target values Pt registered in the storage region 30a and the correction amount α corresponding to the internal pressure target values Pt.

According to the above-described configuration, it is possible to easily and properly inflate the airbags 10 in either of the seated state and non-seated state of the occupant.

(5) When the controller 30, which functions as a provisional correction amount calculation portion 60l, detects the reproduction request in a state in which the occupant is in the seated state, and in which the correction amount α is not registered in the storage region 30a, the controller 30 detects the size of the occupant seated on the seat 1, and calculates the provisional correction amount β to be used to correct the internal pressure target value Pt in the seated state based on the detected size.

According to the above-described configuration, even when the occupant whose correction amount α is not registered is seated on the seat 1, it is possible to properly inflate the airbags 10 to realize the optimum seat support shape. Accordingly, the user's convenience is improved.

(6) The seat device 20 includes the memory operation portion 34 used for the registration request that causes the storage region 30a of the controller 30 to register the internal pressure target value Pt, and used for the reproduction request that causes the airbags 10 to be inflated based on the internal pressure target value Pt registered in the storage region 30a. This memory operation portion 34 also serves as the memory operation portion 48 for seat position adjustment, that is, this memory operation portion 34 is shared by the registration operation and reproduction operation of the seat position.

According to the above-described configuration, the registration request and reproduction operation for adjusting the seat support shape can be performed simultaneously with the registration operation and reproduction operation for adjusting the seat position. Accordingly, the user's convenience is improved.

The above-described embodiment may be modified as follows.

In the above-described embodiment, the size of the occupant seated on the seat 1 is detected based on the slide position X of the seat 1 stored in the storage region 30a as the seat position data Msp. However, this is not a limitation, and the size detection of the occupant may be performed according to other state quantities related to the seat position, such as the lift position Y of the seat cushion 2 and the tilted angle θ of the seat back 3, or according to the combination of state quantities. Additionally, the state quantity used for the size detection of the occupant, including the slide position X, may not be the state quantity stored in the storage region 30a in advance, and may be the state quantity detected at the time of the size detection determination. In this case, the size detection of the occupant may be performed by the other techniques, such as detection of the seat load, or image analysis using an imaging device such as a camera.

In the above-described embodiment, the pressure-sensitive switch (membrane switch), which is switched into the on state when the occupant seated on the seat 1 presses down the seat surface 2s of the seat cushion 2, is used for the seating sensor 33. However, this is not a limitation, and detection of the seated state of the occupant may also be performed by the other techniques, such as detection of the seat load or image analysis using an imaging device, or usage of a buckle switch of a seat belt.

Additionally, the size detection of the occupant may be performed before the occupant is seated on the seat 1, when possible, for example, in a case where image analysis by a camera is used. The correction amount α to be used to correct the internal pressure target value Pt in the non-seated state may be calculated, and inflating of the airbags 10 may be started in light of the fact that this occupant is seated on the seat 1. Further, in this case, the registration request and the reproduction request may not be required. Accordingly, the user's convenience is further improved.

In the above-described embodiment, though the memory operation portion 34 for seat support shape adjustment also serve as the memory operation portion 48 for seat position adjustment, the operation portions 34 and 48 may be provided in different portions. Additionally, the arrangement of the operation portion 34 (48) may also be arbitrarily changed. A portable device for locking/unlocking the vehicle, or a mobile phone, may have a function as the memory operation portion 34.

In the above-described embodiment, the provisional correction reproduction control inflates each of the airbags 10 so that the internal pressure P of each of the airbags 10 becomes the value obtained by adding the provisional correction amount β to the corresponding internal pressure target value Pt (P=Pt+β). However, this is not a limitation, and the calculation methods of the internal pressure target value Pt on which this provisional correction reproduction control is based, and its provisional correction amount β may be arbitrarily changed. That is, the internal pressure target value Pt, which is the object to be corrected in the provisional correction reproduction control, may be set in any manner. Additionally, the provisional correction amount β may increase or may decrease the internal pressure target value Pt by the correction.

The number and arrangement of the airbags 10 provided inside the seat 1 may be arbitrarily changed. Additionally, the configurations of the air pump device 21 and the intake-discharge valve device 22 may also be arbitrarily changed.

In the above-described embodiment, the controller 30 functions as the reproduction control portion 60a, the occupant detection portion 60b, the body size detection portion 60c, the correction amount calculation portion 60d, the registration request detection portion 60e, the internal pressure target value registration portion 60f, the correction amount registration portion 60g, the registered correction amount erasing portion 60h, the reproduction request detection portion 60i, the seated state reproduction control portion 60j, and the non-seated state reproduction control portion 60k. Additionally, the controller 30 further functions as the provisional correction amount calculation portion 60l. However, this is not a limitation, and these function control portions may be distributed in multiple information processing devices.

1. A vehicle seat device comprising:
a reproduction control portion configured to inflate an airbag provided in a seat based on an internal pressure target value;
an occupant detection portion configured to detect a seated state in which an occupant is seated on the seat;
a body size detection portion configured to detect a size of the occupant; and
a correction amount calculation portion configured to calculate, based on the size of the occupant, a correction amount to be used to correct the internal pressure target value in a non-seated state in which the occupant is not seated on the seat.

2. The vehicle seat device according to claim 1, comprising:
a registration request detection portion configured to detect a registration request;
an internal pressure target value registration portion configured to register, when the registration request is detected, a current value of an internal pressure of the airbag in a storage region as the internal pressure target value; and
a correction amount registration portion configured to register, when the registration request is detected in the seated state of the occupant, the correction amount calculated in the seated state in the storage region.

3. The vehicle seat device according to claim 2, comprising a registered correction amount erasing portion configured to erase the correction amount registered in the storage region when the registration request is detected in the non-seated state of the occupant.

4. The vehicle seat device according to claim 2, comprising:
a reproduction request detection portion configured to detect a reproduction request;
a seated state reproduction control portion configured to inflate the airbag based on the internal pressure target value registered in the storage region when the reproduction request is detected in the seated state of the occupant; and
a non-seated state reproduction control portion configured to inflate the airbag based on the internal pressure target value and the correction amount registered in the storage region when the reproduction request is detected in the non-seated state of the occupant.

5. The vehicle seat device according to claim 4, comprising a provisional correction amount calculation portion configured to, when the reproduction request is detected in the seated state of the occupant and in a state in which the correction amount is not registered in the storage region,
detect the size of the occupant, and
calculate, based on the detected size, a provisional correction amount to be used to correct the internal pressure target value in the seated state.

6. The vehicle seat device according to claim 4, wherein the non-seated state reproduction control portion is configured to, when the reproduction request is detected in the non-seated state of the occupant and in a state in which the correction amount is not registered in the storage region, inflate the airbag based on the internal pressure target value registered in the storage region.

7. The vehicle seat device according to claim 1, comprising a memory operation portion used for a registration request that causes the internal pressure target value to be registered in the storage region, and a reproduction request that causes the airbag to be inflated based on the internal pressure target value registered in the storage region,
wherein the memory operation portion is configured to be shared by a registration operation and a reproduction operation of a seat position.

8. A method for controlling air pressure of a vehicle seat, the method comprising:
inflating an airbag provided in a seat based on an internal pressure target value;
detecting a seated state in which an occupant is seated on the seat;
detecting a size of the occupant; and
calculating, based on the size of the occupant, a correction amount to be used to correct the internal pressure target value in a non-seated state in which the occupant is not seated on the seat.

9. The method for controlling air pressure of a vehicle seat according to claim 8, comprising:
detecting a registration request;
registering, when the registration request is detected, a current value of an internal pressure of the airbag in a storage region as the internal pressure target value; and
registering, when the registration request is detected in the seated state of the occupant, the correction amount calculated in the seated state in the storage region.

10. The method for controlling air pressure of a vehicle seat according to claim 9, comprising erasing the correction amount registered in the storage region when the registration request is detected in the non-seated state of the occupant.

11. The method for controlling air pressure of a vehicle seat according to claim 9, comprising:
detecting a reproduction request;
inflating the airbag based on the internal pressure target value registered in the storage region when the reproduction request is detected in the seated state of the occupant; and
inflating the airbag based on the internal pressure target value and the correction amount registered in the storage region when the reproduction request is detected in the non-seated state of the occupant.

12. The method for controlling air pressure of a vehicle seat according to claim 11, comprising, when the reproduction request is detected in the seated state of the occupant and in a state in which the correction amount is not registered in the storage region:
detecting the size of the occupant; and
calculating, based on the detected size, a provisional correction amount to be used to correct the internal pressure target value in the seated state.
